(19) United States
(12) Patent Application Publication
(10) Pub. No.: US 2008/0148148 A1
(43) Pub. Date: Jun. 19, 2008

(54) PROVIDING MODIFIED NOTIFICATIONS WHEN INFERRING A USER MIGHT NOT WANT TO BE NOTIFIED

(75) Inventors: Rajesh Ramanathan, Redmond, WA (US); Eran Shtiegman, Redmond, WA (US); Ankur Chavda, Seattle, WA (US); Justin M. Maguire, Seattle, WA (US); Amritansh Raghav, Seattle, WA (US); Marc Boyer, Seattle, WA (US); Joseph T. Fletcher, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/555,666

(22) Filed: Nov. 1, 2006

(51) Int. Cl. G06F 3/00

(52) U.S. Cl. 715/700

(57) ABSTRACT

A notification system, upon receiving an indication of an event, determines whether the user has requested to suppress event notifications. When the user has requested to suppress event notifications, the notification system suppresses the event notification by not notifying the user of the event. When the user has not requested to suppress event notifications, the notification system infers whether the user wants to suppress event notifications. When the notification system infers that the user does not want to suppress event notifications, the notification system provides to the user a normal event notification. When the notification system infers that the user does want to suppress event notifications, the notification system provides to the user a modified event notification.

### BACKGROUND

Users of computing devices (e.g., laptops, cellular phones, and personal digital assistants) often need to communicate in real time. A common form of real-time communications is provided by instant messaging services. An instant messaging service allows participants at endpoints to send messages and have them received within a second or two by the other participants in a conversation. The receiving participants can then send responsive messages to the other participants in a similar manner. To be effective, a real-time conversation relies on the participants' becoming aware of, reviewing, and responding to received messages very quickly. This quick response is in contrast to conventional electronic mail systems in which the recipients of electronic mail messages respond to messages at their convenience.

When an initiating participant wants to start a real-time conversation, that participant needs to know whether the intended participants are available to respond in real time to a message. If not, then communications via conventional electronic mail, voice mail, or some other mechanism may be more appropriate. For example, if the computing devices of the intended participants are currently powered off, then a real-time conversation may not be possible. Moreover, if their computing devices are currently powered on, but the intended participants are away from their computing devices, a real-time conversation is also not possible. The initiating participant would like to know the availability of the intended participants so that an appropriate decision on the form of communication can be made.

Presence services provide this availability information. The availability status of an entity such as a computing device or a user associated with that computing device is referred to as “presence information.” Presence information identifies the current “presence state” of the user. Users make their presence information available to a presence service so that other users can decide how best to communicate with them. For example, the presence information may indicate whether a user is logged on (“online”) with an instant messaging service or is logged off (“offline”). Presence information may also provide more detailed information about the availability of the user. For example, even though a user is online, that user may be away from their computing device in a meeting. In such a case, the presence state may indicate “online” and “in a meeting.”

When a real-time communication is sent to a user, the user is typically notified that the communication has been received. For example, a real-time communication client may display a pop-up window indicating that a communication has been received along with the other information. The other information may include the identification of the sender of the real-time communication, subject of the real-time communication, and so on. The pop-up window may also include controls for selecting to review the real-time communication, dismissing the pop-up window, and so on.

Users may find pop-up windows or other types of notifications of real-time communications to be both annoying and distracting. For example, a pop-up window that is displayed while the user is creating a document or engaging in another online conversation (e.g., an online conference) or other activity may be distracted from their current activity. To prevent such distractions and subsequent annoyances, real-time communication clients allow users the option of suppressing such notifications. To suppress such notifications, a user may select a menu option provided by the real-time communication client. Similarly, to resume receiving the notifications, the user may also select a menu option.

Users, however, may not have selected the option to suppress such notifications when starting an activity from which they do not want to be distracted. When such users receive a notification of a real-time communication, the users again may become annoyed and distracted. Such users may even be increasingly annoyed because they have to search for and select the menu option to suppress further notifications. Moreover, such users after selecting to suppress notifications may forget to select the option to resume receiving the notifications. Again, the user will be annoyed when they find out that they missed a real-time communication.

To help alleviate some of the annoyance and distraction of such users, a real-time communication client may try to infer when a user does not want to receive such notifications. For example, a real-time communication client may determine that the user is actively editing a document, the user is in a meeting based on a calendar entry, the user is participating in an online conference, the user is presenting a slideshow, and so on and does not want to be interrupted. When the real-time communication client determines that a user does not want to receive such notifications, it suppresses the notification. Otherwise, the real-time communication client provides the notification to the user.

When a real-time communication client correctly infers that a user does not want to receive notifications, the user's experience with the real-time communication client is positive. If, however, the real-time communication client makes an incorrect inference, the user becomes annoyed regardless of whether a notification is suppressed. If the real-time communication client incorrectly infers that the user does not want to be interrupted, it does not notify the user of communication that the user wants to know about. When the user eventually finds out that a real-time communication was missed, the user may become annoyed. Conversely, if the real-time communication client incorrectly infers that the user does want to be interrupted, then it notifies the user of the communication and the user may become annoyed and distracted. If the real-time communication client uses a more restrictive inference so that notifications are suppressed in fewer instances, the user may get annoyed at receiving too many notifications. Conversely, if the real-time communication client uses a less restrictive inference so that notifications are suppressed in more instances, then the user may get annoyed at missing too many real-time communications.

### SUMMARY

A method and system for controlling event notifications is provided. A notification system, upon receiving an indication of an event, determines whether the user has requested to suppress event notifications. When the user has requested to suppress event notifications, the notification system suppresses the event notification by not notifying the user of the event. When the user has not requested to suppress event notifications, the notification system infers whether the user wants to suppress event notifications. When the notification system infers that the user does not want to suppress event notifications, the notification system provides to the user a normal event notification. When the notification system infers that the user does want to suppress event notifications, the notification system provides to the user a modified event notification.

The notification system provides a technique for receiving a request from a user to suppress event notifications. The notification system, upon receiving an indication of an event, determines whether the user has requested to suppress event notifications. When the user has requested to suppress event notifications, the notification system suppresses the event notification. When the user has not requested to suppress event notifications, the notification system provides to the user a notification of the event. The notification provides a means for the user to request to suppress event notifications. For example, if the notification is a pop-up window, the notification system may add a button to the pop-up window that the user can select to request to suppress event notifications. When the user takes the identified action, the notification system indicates that event notifications are to be suppressed.

The notification system provides a technique for terminating the suppression of event notifications. When a user requests to suppress event notifications, the user also identifies a termination condition for the suppression of event notifications. After receiving a request to suppress event notifications along with a termination condition, the notification system may receive an indication of an event. When the indication is received before the termination condition has occurred, the notification system suppresses notification of the event. When the indication is received after the termination condition has occurred, the notification system notifies the user of the event.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a display page that illustrates a prior art normal event notification.

FIG. 2 is a display page that illustrates a modified event notification in one embodiment.

FIG. 3 is a display page that illustrates a modified event notification and selection of termination condition in one embodiment.

FIG. 4 is a display page that illustrates selection of a termination condition outside the context of an event notification in one embodiment.

FIG. 5 is a block diagram that illustrates components of the notification system in one embodiment.

FIG. 6 is a flow diagram that illustrates the processing of the receive event component of the notification system in one embodiment.

FIG. 7 is a flow diagram that illustrates the processing of the provide event notification component of the notification system in one embodiment.

FIG. 8 is a flow diagram that illustrates the processing of the input suppress event notification selection component of the notification system in one embodiment.

FIG. 9 is a flow diagram that illustrates the processing of the receive event with termination condition component of the notification system in one embodiment.

### DETAILED DESCRIPTION

A method and system for controlling event notifications is provided. In one embodiment, a notification system, upon receiving an indication of an event, determines whether the user has requested to suppress event notifications. For example, the user may have manually selected an option of a menu to suppress event notifications. When the user has requested to suppress event notifications, the notification system suppresses the event notification by not notifying the user of the event. When the user has not requested to suppress event notifications, the notification system infers from information available to the computing device whether the user wants to suppress event notifications. When the notification system infers that the user does not want to suppress event notifications, the notification system provides to the user a normal event notification. For example, when the event is the receiving of a real-time communication, a normal event notification may be a pop-up window that identifies the real-time communication and provides the name of the sender along with the subject of the communication. When the notification system infers that the user does want to suppress event notifications, the notification system provides to the user a modified event notification. A modified event notification may be less intrusive than, more private than, or in some other way different from a normal event notification. The modified event notification may be less intrusive by being displayed in a less prominent location than a normal event notification, being displayed on a secondary display, being a subtle audible notification, and so. In this way, if an inference that the user does not want to suppress events notifications is incorrect, the notification system provides at least a modified notification that may be less intrusive, more private, and so on. Moreover, the user can manually indicate that event notifications be suppressed to prevent even a modified event notification when the inference is incorrect.

In one embodiment, the notification system provides a technique for receiving a request from a user to suppress event notifications. The notification system, upon receiving an indication of an event, determines whether the user has requested to suppress event notifications. When the user has requested to suppress event notifications, the notification system suppresses the event notification by not providing an event notification to the user. When the user has not requested to suppress event notifications, the notification system provides to the user a notification of the event. The notification identifies an action that the user can take to request to suppress event notifications. For example, if the notification is a pop-up window, the notification system may add a button to the pop-up window that indicates that the user can request to suppress event notifications by selecting the button. When the user takes the identified action, the notification system indicates that event notifications are to be suppressed. In this way, when the notification system provides an event notification to the user that the user does not want to receive, the user can quickly perform the action (e.g., select a displayed button) to request that event notifications be suppressed. Thus, the user does not need to navigate through a menu system to identify a menu item to suppress event notifications and be further distracted.

In one embodiment, the notification system provides a technique for terminating the suppression of event notifications, that is, resuming the receipt of event notifications. When a user requests to suppress event notifications, the user also identifies a termination condition for the suppression of event notifications or a resumption condition for receipt of event notifications. For example, a termination condition may be after a certain time, when an application that is the focus of the user's attention terminates or is no longer the focus of the user's attention, when the notification system infers that the user wants to resume receiving event notifications, and so on. After receiving a request to suppress event notifications along with a termination condition, the notification system may receive an indication of an event. When the indication is received before the termination condition has occurred, the notification system suppresses notification of the event. When the indication is received after the termination condition has occurred, the notification system notifies the user of the event. In this way, the suppression of event notifications will terminate automatically after a termination condition has been satisfied.

In one embodiment, the notification system may combine various aspects of the invention. The notification system may provide modified notifications when it infers that the user does not want to receive event notifications. The notification system may include within the modified notifications a means for the user to quickly request suppression of event notifications. In addition, the notification system may allow the user to specify a termination condition when the user requests suppression of event notifications.

In one embodiment, the notification system can control providing event notifications to users for arbitrary types of events. As examples, the events may relate to real-time communications such as receipt of instant messages, receipt of an incoming VoIP call, termination of a conference call, receipt of a sports score, receipt of a stock price, and so on. The events may also relate to calendar events such as a reminder of an upcoming meeting, start and end of a meeting, cancellation of a meeting, rescheduling of a meeting, reminder of a birthday, reminder of a task, and so on. The events may also relate to electronic mail messages such as receipt of electronic mail message, reminder that a reply to an electronic mail message has not been received, and so on. The events may relate to status of a computing device such as low battery, an update is pending, disk space is low, a certain component is malfunctioning, and so on.

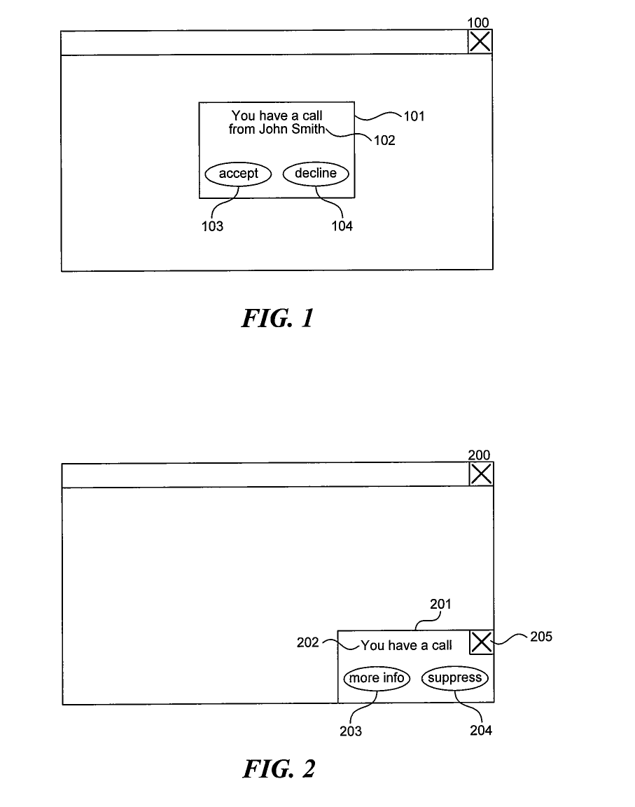

FIG. 1 is a display page that illustrates a prior art normal event notification. Display page 100 includes a normal event notification 101. The normal event notification includes information 102 that includes a description of the event, in this case an incoming telephone call, and the name of the caller. The normal event notification also includes an accept button 103 and a decline button 104. When the user selects the accept button, the telephone call is answered. When the user selects the decline button, the telephone call is not answered and the event notification is dismissed.

FIG. 2 is a display page that illustrates a modified event notification in one embodiment. Display page 200 includes a modified event notification 201 displayed in the lower right corner of the display page. The modified event notification includes information 202, a more information button 203, a suppress button 204, and a dismiss button 205. In this example, the information of the modified event notification provides less information than a corresponding normal event notification. Because the modified event notification does not identify the caller, it provides more privacy to the user. For example, a user who is presenting a slideshow may want a more private notification during the slideshow so that personal, sensitive, confidential, or other type of private information is not revealed by the event notification. The user may select the more information button to view more information about the event. The user can select the suppress button to request to suppress further event notifications. The user can select the dismiss button to dismiss the modified event notification. In general, a user will find the modified event notification to be more desirable than a normal event notification if the notification incorrectly infers or determines that the user wants to receive event notifications.

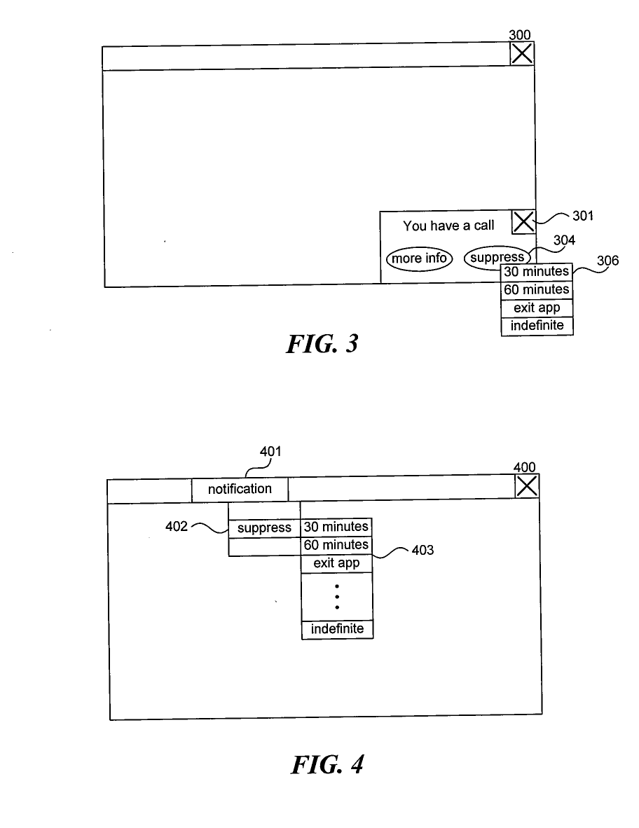

FIG. 3 is a display page that illustrates a modified event notification and selection of termination condition in one embodiment. Display page 300 includes a modified event notification 301 that includes a suppress button 304 and a termination condition drop-down 306. When a user selects the suppress button, the notification system may display the termination condition drop-down list. The drop-down list includes various termination conditions that the user may select. For example, the user may select a 60-minute termination condition to automatically terminate the suppressing of event notifications after 60 minutes. The user may select the indefinite termination condition to prevent the automatic termination of the suppression of event notifications. Rather than displaying the termination conditions in a drop-down list, the notification system may display the termination conditions as buttons within the event notification. When a user selects one of the termination conditions buttons, the notification system starts suppressing event notifications with that termination condition.

FIG. 4 is a display page that illustrates selection of a termination condition outside the context of an event notification in one embodiment. Display page 400 includes a menu 401 that includes a suppress menu item 402. When the user selects the suppress menu item, the notification system displays menu sub-items 403. The sub-items correspond to the termination conditions. Thus, when a user manually indicates to suppress event notifications outside of an event notification context, the notification system allows the user to select termination conditions.

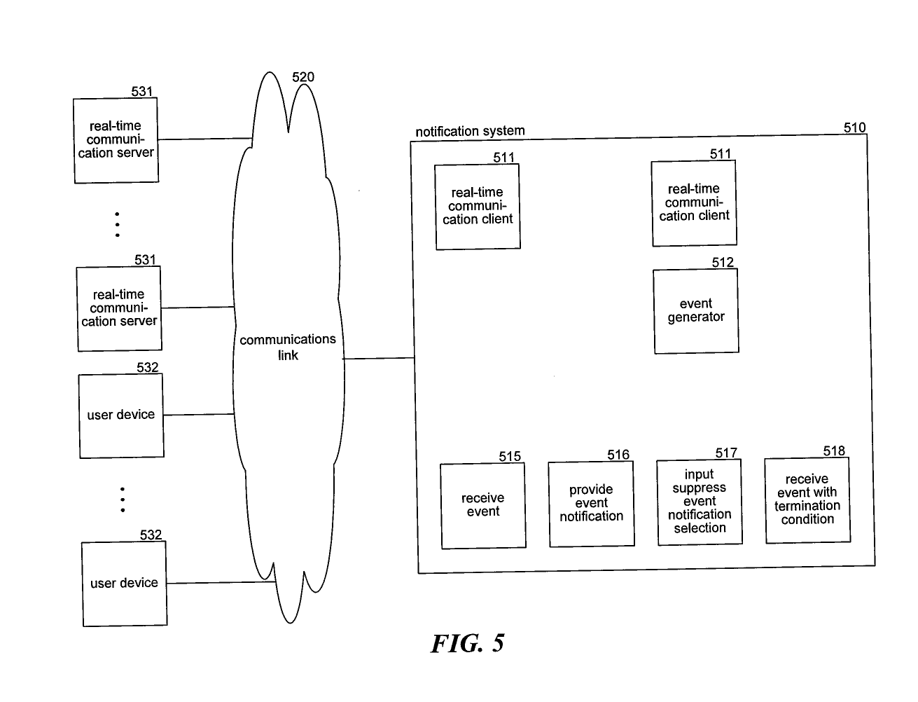

FIG. 5 is a block diagram that illustrates components of the notification system in one embodiment. The notification system 510 may be implemented on a user computing device. The user computing device may be connected via communications link 520 to real-time communication servers 531 and other user devices 532. The notification system may include real-time communication clients 511 and an event generator 512. The real-time communication clients receive communications from real-time communication servers and provide indications of associated events. The event generator generates indications of various types of events that may be received from other computing devices or derived from information within the user computing device. The notification system also includes a receive event component 515, a provide event notification component 516, an input suppress event notification selection component 517, and a receive event with termination condition component 518. The receive event component receives an indication of an event and provides a modified event notification when the notification system infers that the user does want to suppress events, that is determines that the user does not want to be notified of events. The provide event notification component provides an event notification to the user and includes within the notification a means to request to suppress event notifications. The input suppress event notification selection component allows a user to request to suppress event notifications and to specify termination conditions. The receive event with termination condition component receives an indication of an event and provides a modified event notification that allows selection of termination conditions when the notification system infers that the user does not want to be notified of events.

The computing device on which the notification system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the notification system, which means a computer-readable medium that contains the instructions. In addition, the instructions, data structures, and message structures may be stored or transmitted via a data transmission medium, such as a signal on a communications link. Various communications links may be used, such as the Internet, a local area network, a wide area network, a point-to-point dial-up connection, a cell phone network, and so on.

Embodiments of the notification system may be implemented in various operating environments that include personal computers, server computers, hand-held or laptop devices, multiprocessor systems, microprocessor-based systems, programmable consumer electronics, digital cameras, network PCs, minicomputers, mainframe computers, cell phones, personal digital assistants, smart phones, personal computers, programmable consumer electronics, distributed computing environments that include any of the above systems or devices, and so on.

The notification system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

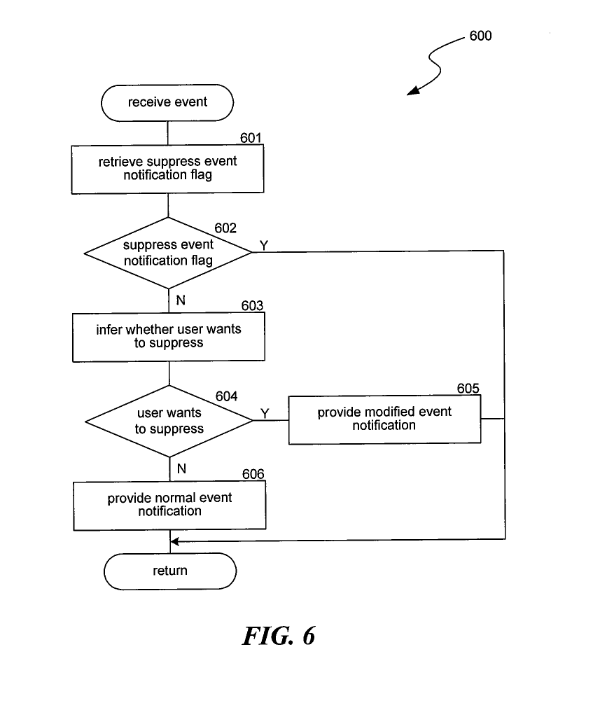

FIG. 6 is a flow diagram 600 that illustrates the processing of the receive event component of the notification system in one embodiment. The component receives an indication of an event and displays a modified event notification based on inferring whether the user wants to suppress event notifications. In block 601, the component retrieves a suppress event notification flag. The suppress event notification flag is set to indicate that the user wants to suppress event notifications. In decision block 602, if the suppress event notification flag is set, then the component suppresses the event notification by returning, else the component continues at block 603. In block 603, the component infers whether the user wants to suppress event notifications. In decision block 604, if it is inferred that the user wants to suppress event notifications, then the component continues at block 605, else the component continues at block 606. In block 605, the component provides to the user a modified event notification and returns. In block 606, the component provides to the user a normal event notification and then returns. In an alternate embodiment, the notification system may allow a user to specify whether to enable the inference when the suppress event notification flag is clear. If the inference is disabled, then the notification system simply provides the normal event notification when an indication of an event is received. If the inference is enabled, the notification system may also allow the user to further specify whether to provide a modified event notification or no event notification when it is inferred that the user wants to suppress event notifications. Thus, to provide the behavior described in FIG. 6, a user would clear the suppress event notification flag, enable inference, and enable the providing of modified event notifications.

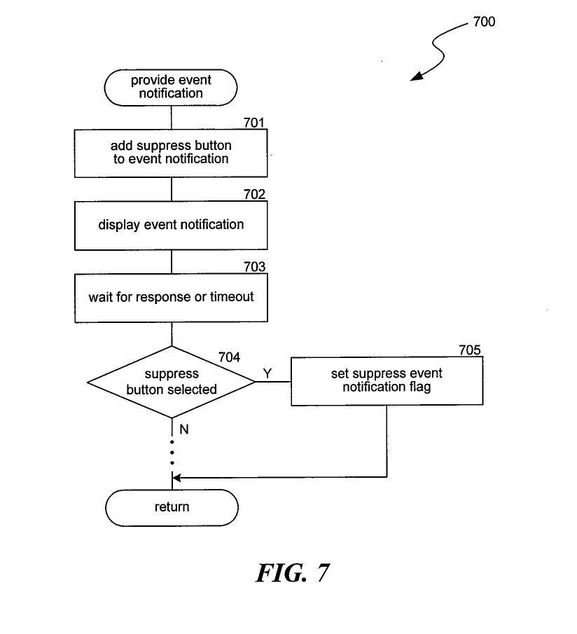

FIG. 7 is a flow diagram 700 that illustrates the processing of the provide event notification component of the notification system in one embodiment. The component provides an event notification with a means for the user to request to suppress event notifications. In block 701, the component adds a suppress button to the event notification. In block 702, the component displays the event notification. In block 703, the component waits for a user response or a timeout and then continues. In decision block 704, if the user's response is to select a suppress button, then the component continues at block 705, else the component continues to process other user responses. In block 705, the component sets the suppress event notification flag to indicate that notifications of subsequent events are to be suppressed and then returns.

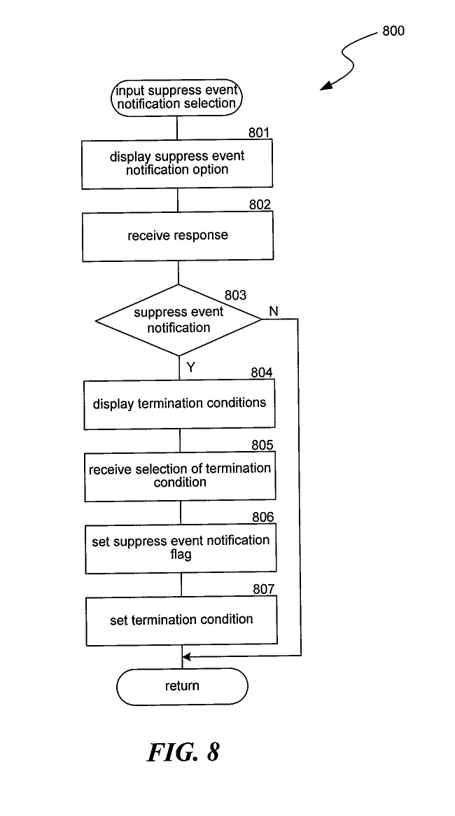

FIG. 8 is a flow diagram 800 that illustrates the processing of the input suppress event notification selection component of the notification system in one embodiment. The component is invoked to input a selection to suppress event notifications along with a termination condition. In block 801, the component displays a suppress event notification option, such as when a menu item relating to notifications is selected. In block 802, the component receives a response. In decision block 803, if the user's response is to suppress event notifications, then the component continues at 804, else the component returns. In block 804, the component displays various termination conditions. In block 805, the component receives from the user selection of a termination condition. In block 806, the component sets the suppress event notification flag. In block 807, the component sets the termination condition and then returns.

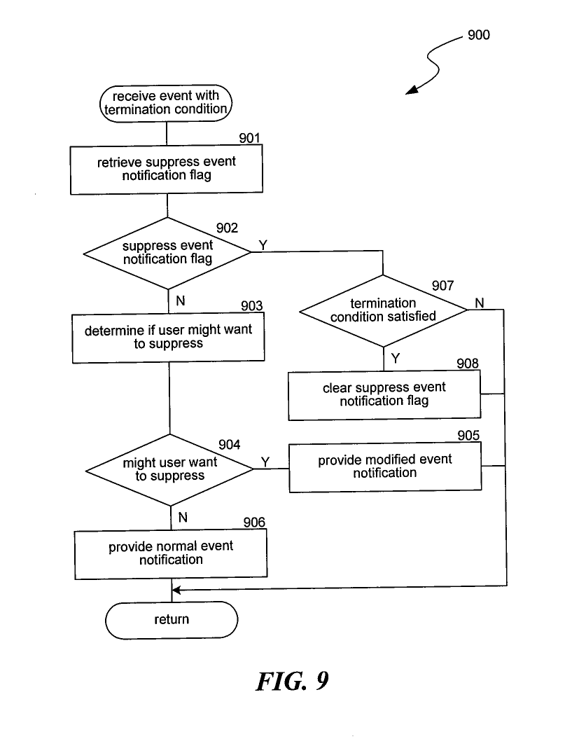

FIG. 9 is a flow diagram 900 that illustrates the processing of the receive event with termination condition component of the notification system in one embodiment. The component receives an event and provides an option for the user to select a termination condition when the user requests to suppress event notifications. In block 901, the component retrieves a suppress event notification flag. The suppress event notification flag is set to indicate that the user wants to suppress event notifications. In decision block 902, if the suppress event notification flag is set, then the component continues at block 907, else the component continues at block 903. In block 903, the component infers whether the user wants to suppress event notifications. In decision block 904, if it is inferred that the user wants to suppress event notifications, then the component continues at block 905, else the component continues at block 906. In block 905, the component provides to the user a modified event notification and returns. In block 906, the component provides to the user a normal event notification and then returns. In decision block 907, if the termination condition is satisfied, then the component continues at block 908, else the component returns. In block 908, the component clears the suppress event notification flag and returns.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method in a computing device for controlling event notifications, the method comprising:
receiving an indication of an event;
determining whether the user has requested to suppress event notifications;
when the user has requested to suppress event notifications, suppressing the notification of the event; and
when the user has not requested to suppress event notifications, inferring whether the user wants to suppress event notifications;
when it is inferred that the user does not want to suppress event notifications, providing to the user a normal event notification; and
when it is inferred that the user wants to suppress event notifications, providing to the user a modified event notification that the user will likely find more desirable than a normal event notification when this inference is incorrect.

2. The method of claim 1 wherein the modified notification provides a means for the user to request to suppress event notifications.

3. The method of claim 1 wherein the modified notification includes a button that the user selects to request to suppress event notifications.

4. The method of claim 1 wherein the modified notification is the display of the same content of the normal notification, but on a secondary display of the user.

5. The method of claim 1 wherein the modified notification provides a means for the user to request to suppress event notifications and to specify a termination condition.

6. The method of claim 5 wherein the termination condition is elapse of a time period.

7. The method of claim 5 wherein the termination condition is terminating execution of an application that is currently executing on the computing device.

8. The method of claim 1 wherein the event is receipt of a communication from another user.

9. The method of claim 1 wherein the event is automatically generated from information available to the computing device.

10. A computer-readable medium encoded with computer-executable instructions for controlling a computing device to receive a request from a user to suppress event notifications, by a method comprising:
receiving an indication of an event;
determining whether the user has requested to suppress event notifications;
when the user has requested to suppress event notifications, suppressing the notification of the event; and
when the user has not requested to suppress event notifications,
providing to the user a notification of the event, the notification providing a means for the user to request to suppress event notifications; and
when the user uses the means to request to suppress event notifications, suppressing event notifications for subsequent events.

11. The computer-readable medium of claim 10 including:
before providing the notification to the user,
inferring whether the user wants to suppress event notifications; and
when it is inferred that the user wants to suppress event notifications, the notification provided is a modified event notification such that the user will likely find it more desirable than a normal event notification when this inference is incorrect.

12. The computer-readable medium of claim 11 wherein a modified event notification is displayed on a secondary display of the user.

13. The computer-readable medium of claim 10 wherein means for the user to request to suppress event notifications is the selecting of a button included with the notification.

14. The computer-readable medium of claim 10 wherein when the user uses the means to request to suppress event notifications, the user can specify a termination condition for suppressing the notifications of events.

15. The computer-readable medium of claim 14 wherein the termination condition is elapse of a time period.

16. The computer-readable medium of claim 14 wherein the termination condition is terminating execution of an application that is currently the focus of the user's attention.

17. A computer-readable medium encoded with computer-executable instructions for controlling a computing device to terminate suppression of event notifications to a user, by a method comprising:
receiving from the user a request to suppress event notifications along with a termination condition; and
after receiving from the user the request to suppress event notifications, receiving indications of events;
when an indication of an event is received before the termination condition has occurred, suppressing a notification of the event; and
when an indication of an event is received after the termination condition has occurred, providing to the user a notification of the event.

18. The computer-readable medium of claim 17 wherein the receiving includes:
after the request to suppress event notification is received, displaying termination conditions; and
receiving from the user a selection of a displayed termination condition.

19. The computer-readable medium of claim 17 wherein the request to suppress event notifications is requested via means provided by the notification.

20. The computer-readable medium of claim 17 including before receiving from the user a request to suppress event notifications,
receiving an indication of an event;
inferring whether the user wants to suppress event notifications; and
when it is inferred that the user wants to suppress event notifications, the notification provided is a modified event notification such that the user will likely find it more desirable than a normal event notification when this inference is incorrect.
